(19) United States
(12) Patent Application Publication
(10) Pub. No.: US 2026/0102929 A1
(43) Pub. Date: Apr. 16, 2026

(54) GRIPPING DEVICE AND SYSTEM FOR ASSEMBLING CONNECTOR IN VEHICLE

(71) Applicants: Hyundai Motor Company, Seoul (KR); Kia Corporation, Seoul (KR)

(72) Inventor: Ji Eun Jang, Hwaseong (KR)

(21) Appl. No.: 19/199,119

(22) Filed: May 5, 2025

(30) Foreign Application Priority Data
Oct. 11, 2024 (KR) 10-2024-0138176

(51) Int. Cl. B25J 15/00; H01R 43/00

(52) U.S. Cl. CPC B25J 15/0033; H01R 43/00; H01R 2201/26

(57) ABSTRACT

A gripping device is configured to assemble a connector to a vehicle. An automatic connector assembling system may use the gripping device, and capture a two-dimensional image of an input connector or an output connector of each of a plurality of wiring connectors by a vision camera, detect a position of the input connector or the output connector detect a three-dimensional precise position and angle of the input connector or the output connector by moving the vision camera grip the input connector or the output connector for inserting and fastening the input connector or the output connector into a connection port of an electrical component.

### CROSS-REFERENCE TO RELATED APPLICATION

This application claims under 35 U.S.C. § 119(a) the benefit of Korean Patent Application No. 10-2024-0138176 filed on Oct. 11, 2024, the entire contents of which are incorporated herein by reference.

### BACKGROUND

### (a) Technical Field

The present disclosure relates to a gripping device for assembling a connector and a vehicle assembly system using the same, more particularly, to the gripping device and the vehicle assembly system that are capable of accurately coupling wiring connectors, which are arranged in a non-aligned state, to an assembling target component.

### (b) Description of the Related Art

In general, a vehicle is equipped with a plurality of electrical components, and the electrical components are connected to one another by wiring connectors to supply electric current, establish communication, and exchange control signals.

The wiring connector is manufactured to have a structure in which an input connector (referred to as a ‘head connector’) and an output connector are connected by wiring to supply electric current to the electric components, establish communication between the electrical components, and exchange control signals.

For example, the wiring connector may be manufactured in a shape in which one input connector and one output connector are connected in a one-to-one manner by wiring, or the wiring connector may be manufactured in a shape in which one input connector and two or more output connectors are connected by wiring.

An assembling process of connecting the plurality of electrical components by using the wiring connectors, i.e., an assembling process of inserting and fastening the input connector and the output connector of the wiring connector into a corresponding connection port of the electrical component is manually performed by an operator.

However, a layout space in which the wiring connector is installed is limited, and the number of wiring connectors to be assembled to connect the electrical components is excessively larger than the number of electrical components to be mounted in the vehicle. For this reason, there is a problem in that the operator's workability in assembling the connector deteriorates significantly.

In addition, during the wiring connector assembling operation repeatedly performed by the operator, the input connector and the output connector of the wiring connector are not sometimes fastened robustly to the connection port of the electrical component, which subsequently causes a problem in that there occur defects in supplying electric current to the electrical component and exchanging signals.

Accordingly, there is a need for a solution capable of automatically assembling the wiring connector to the electrical component.

The above information disclosed in this Background section is only for enhancement of understanding of the background of the invention and therefore it may contain information that does not form the prior art that is already known in this country to a person of ordinary skill in the art.

### SUMMARY

The present disclosure provides a gripping device for assembling a connector and an automatic connector assembling system using the same, which are capable of automatically performing a process of capturing a two-dimensional image of an input connector or an output connector of each of a plurality of wiring connectors by a vision camera, which is mounted on a robot, in a state in which the plurality of wiring connectors is mounted on a loading device or a hanging device in a non-aligned state with different arrangements, a process of detecting a position of the input connector or the output connector by means of deep learning computation of a control unit on the basis of the captured two-dimensional image, a process of detecting a three-dimensional precise position and angle of the input connector or the output connector by moving the vision camera to a detection position for the input connector or the output connector by an operation of the robot, and a connector assembling process of gripping the input connector or the output connector and then inserting and fastening the input connector or the output connector into a connection port of an electrical component by a pair of finger plates mounted at a tip portion of the robot.

In order to achieve the above-mentioned object, one embodiment of the present disclosure provides a gripping device for assembling a connector in a vehicle, the gripping device including: first and second plates configured to grip an input connector or an output connector of a wiring connector; one or more drive devices mounted on a robot and configured to: rotate the first and second plates in an upward/downward direction, rotate the first and second plates in a leftward/rightward direction, and rectilinearly move the first and second plates in a forward/rearward direction.

In particular, the one or more drive devices may include a first drive device mounted at a tip end of the robot for rotating the first and second plates in the upward/downward direction, a second drive device mounted between the first drive device and the first and second plates for rotating the first and second plates in the leftward/rightward direction, and a third drive device mounted between the first drive device mounted between the first drive device and the first and second plates for rectilinearly moving the first and second plates in the forward/rearward direction.

According to another aspect, a gripping device for assembling a connector may include: first and second finger plates configured to grip an input connector or an output connector of a wiring connector; a first drive device mounted at a tip end of a robot and configured to rotate the first and second finger plates in an upward/downward direction; a second drive device mounted between the first drive device and the first and second finger plates and configured to rotate the first and second finger plates in a leftward/rightward direction; and a third drive device mounted between the first drive device and the first and second finger plates and configured to rectilinearly move the first and second finger plates in a forward/rearward direction.

In the embodiment of the present disclosure, the first drive device may include: a first motor mounted at the tip end of the robot; and an upward/downward rotation frame connected to an output part of the first motor, configured to be rotatable upward or downward, and connected to the second drive device.

In the embodiment of the present disclosure, the second drive device may include: a base plate; a second motor mounted on a bottom surface portion of one side of the base plate; a rotary shaft mounted at a center position of an outer surface portion of the upward/downward rotation frame; and a gear train mounted between the output part of the second motor and the rotary shaft and configured by combining a plurality of gears configured to rotate the base plate leftward or rightward about the rotary shaft.

In the embodiment of the present disclosure, the third drive device may include: a third motor mounted on a bottom surface portion of the other side of the base plate; a gearbox connected to an output part of the third motor and mounted on an upper surface portion of the base frame; first and second rail plates mounted on an upper surface portion of the gearbox; a first rack gear fastened to the first rail plate, configured to be movable forward or rearward, and having an outer end to which the first finger plate is connected; a second rack gear fastened to the second rail plate, configured to be movable forward or rearward, and having an outer end to which the second finger plate is connected; and a pinion connected to an output part of the gearbox and configured to engage with the first and second rack gears.

In addition, a connection bar may be connected between one of the gears of the gear train and the base plate.

In the embodiment of the present disclosure, balls may be mounted in inner surfaces of the first and second finger plates so as to enter or exit the inner surfaces of the first and second finger plates, and springs may be embedded in the first and second finger plates and elastically support the balls.

In order to achieve the above-mentioned object, another embodiment of the present disclosure provides an automatic connector assembling system including: a loading device configured to mount a plurality of wiring connectors, which each is configured by connecting an input connector and an output connector by wiring, in a non-aligned state; an assembling table onto which an electrical component having a plurality of connection ports is seated and fixed; a hanging device configured to mount the wiring and output connectors in the non-aligned state when the input connector is inserted and fastened into one of the connection ports of the electrical component; an articulated robot configured to perform forward and rearward motions, leftward and rightward motions, and upward and downward motions to move to the loading device, the assembling table, and the hanging device; a vision camera mounted at a tip portion of the robot to capture a two-dimensional image or a three-dimensional image of the input connector or the output connector; a gripping device mounted at a tip end of the robot and configured to grip the input connector or the output connector; and a controller configured to control motions of the robot and the gripping device to grip the input connector or the output connector and fasten the input connector or the output connector to the connection port of the electrical component on the basis of image capturing information of the vision camera.

The loading device may include: a transfer table having a roller mounted on a bottom surface portion thereof; and a mounting frame mounted on the transfer table so that the plurality of wiring connectors is mounted in the non-aligned state.

In particular, the mounting frame may include: a plurality of vertical frames mounted at different heights on the transfer table; a plurality of horizontal frames arranged at different heights, connected between the vertical frames, and configured to mount the input connector of the wiring connector; and a mounting space formed between the horizontal frames to arrange the wiring and output connectors of the wiring connector downward.

The hanging device may include: a vertical bar arranged at a front position of one side of the assembling table; and a mounting bar connected to an upper end of the vertical bar so that the wiring and output connectors are mounted in the non-aligned state when the input connector is inserted and fastened into one of the connection ports of the electrical component by the robot and the gripping device.

The automatic connector assembling system of the present disclosure may further include: a transfer rail on which a lower portion of the articulated robot is mounted to be slidable leftward or rightward to increase distances of leftward and rightward motions of the articulated robot.

The vision camera may be configured to transmit a two-dimensional image signal, which is obtained by primarily capturing an image of the input connector mounted on the loading device, to the controller and transmit a three-dimensional image signal, which is obtained by secondarily capturing an image of the input connector mounted on the loading device, to the controller, and the vision camera may be configured to transmit a three-dimensional image signal, which is obtained by capturing an image of the output connector mounted on the hanging device, to the controller.

In another embodiment of the present disclosure, the gripping device may include: first and second finger plates configured to hold the input connector or the output connector of the wiring connector; balls mounted in inner surfaces of the first and second finger plates so as to enter or exit the inner surfaces of the first and second finger plates; springs embedded in the first and second finger plates and configured to elastically support the balls; a first drive device mounted at the tip end of the robot and configured to rotate the first and second finger plates in an upward/downward direction; a second drive device mounted between the first drive device and the first and second finger plates and configured to rotate the first and second finger plates in a leftward/rightward direction; and a third drive device mounted between the first drive device and the first and second finger plates and configured to rectilinearly move the first and second finger plates in a forward/rearward direction.

The first drive device may include: a first motor mounted at the tip end of the robot; and an upward/downward rotation frame connected to an output part of the first motor, configured to be rotatable upward or downward, and connected to the second drive device, the second drive device may include: a base plate; a second motor mounted on a bottom surface portion of one side of the base plate; a rotary shaft mounted at a center position of an outer surface portion of the upward/downward rotation frame; and a gear train mounted between an output part of the second motor and the rotary shaft and configured by combining a plurality of gears configured to rotate the base plate leftward or rightward about the rotary shaft, and the third drive device may include: a third motor mounted on a bottom surface portion of the other side of the base plate; a gearbox connected to an output part of the third motor and mounted on an upper surface portion of the base frame; first and second rail plates mounted on an upper surface portion of the gearbox; a first rack gear fastened to the first rail plate, configured to be movable forward or rearward, and having an outer end to which the first finger plate is connected; a second rack gear fastened to the second rail plate, configured to be movable forward or rearward, and having an outer end to which the second finger plate is connected; a pinion connected to an output part of the gearbox and configured to engage with the first and second rack gears; and a connection bar provided between one of the gears of the gear train and the base plate.

According to another embodiment of the present disclosure, when a force by which the first and second finger plates hold the input connector or the output connector is at a preset level or higher by electric current control of the controller in a state in which the balls are in contact with the input connector or the output connector, the balls may be inserted into the first and second finger plates while compressing the springs.

In contrast, when a force by which the first and second finger plates hold the input connector or the output connector is less than a preset level by electric current control of the controller, the balls may protrude from the inner surfaces of the first and second finger plates and come into contact with the input connector or the output connector by elastic restoring forces of the springs.

The controller may be configured to detect a position of the input connector of the wiring connector mounted on the loading device in the non-aligned state by performing deep learning on the basis of a two-dimensional image signal of the input connector captured by the vision camera.

In addition, the controller may be configured to detect a three-dimensional precise position and arrangement angle of the input connector of the wiring connector mounted on the loading device in the non-aligned state or the output connector of the wiring connector mounted on the hanging device on the basis of a three-dimensional image signal of the input connector or the output connector captured by the vision camera.

In addition, the controller may be configured to control motions of the robot and the gripping device to grip the input connector or the output connector and fasten the input connector or the output connector to the connection port of the electrical component on the basis of a result of detecting the three-dimensional precise position and arrangement angle of the input connector or the output connector of the wiring connector.

In particular, the controller may be configured to perform control to rotate the gripping device in a spiral direction when the gripping device grips the input connector or the output connector and fastens the input connector or the output connector to the connection port of the electrical component.

The present disclosure provides the following effects through the above-mentioned solutions.

First, in the state in which the wiring connector is arranged in the non-aligned state, the position and arrangement angle of the input connector or the output connector of the wiring connector may be accurately detected by deep learning computation and the like, and the robot and the gripping device may grip the input connector or the output connector and automatically insert and fasten the input connector or the output connector into the connection port of the electrical component on the basis of the detected position and arrangement angle, thereby implementing the automation of the connector assembling process.

Second, with the implementation of the automation of the connector assembling process, it is possible to improve the connector assembling workability and productivity and prevent an assembling defect that occurs when wiring connectors in the related art are repeatedly assembled manually.

Other aspects and preferred embodiments of the invention are discussed infra.

### BRIEF DESCRIPTION OF THE DRAWINGS

The above and other features of the present disclosure will now be described in detail with reference to certain exemplary embodiments thereof illustrated in the accompanying drawings which are given hereinbelow by way of illustration only, and thus are not limitative of the present disclosure, and wherein:

FIG. 1 is a perspective view illustrating an automatic connector assembling system according to the present disclosure;

FIG. 2 is a perspective view illustrating a state in which a vision camera of the automatic connector assembling system according to the present disclosure scans an input connector of a wiring connector mounted on a loading device in a non-aligned state;

FIG. 3 is a perspective view illustrating a state in which a gripping device of the automatic connector assembling system according to the present disclosure grips the input connector of the wiring connector mounted on the loading device in the non-aligned state;

FIG. 4 is a perspective view illustrating a state in which the gripping device of the automatic connector assembling system according to the present disclosure grips the input connector and then is moved toward an assembling table by an articulated robot;

FIG. 5 is a perspective view illustrating a state in which wiring and output connectors are automatically mounted on a hanging device when the gripping device of the automatic connector assembling system according to the present disclosure grips the input connector and then is moved toward the assembling table by the operation of the articulated robot;

FIG. 6 is a perspective view illustrating a state in which the input connector is inserted and fastened into one of the connection ports of the electrical component fixed to the assembling table by the gripping device of the automatic connector assembling system according to the present disclosure;

FIG. 7 is a perspective view illustrating a state in which the gripping device of the automatic connector assembling system according to the present disclosure moves to the hanging device, and the vision camera scans the output connector of the wiring connector mounted on the hanging device in the non-aligned state;

FIG. 8 is a perspective view illustrating a state in which the gripping device of the automatic connector assembling system according to the present disclosure grips the output connector;

FIG. 9 is a perspective view illustrating a state in which the gripping device of the automatic connector assembling system according to the present disclosure is moved back to the assembling table by the operation of the articulated robot, and then the gripping device inserts and fastens the output connector into another of the connection ports of the electrical component fixed to the assembling table;

FIG. 10 is a control configuration view of the automatic connector assembling system according to the present disclosure;

FIGS. 11 and 12 are perspective views illustrating the gripping device used for the automatic connector assembling system according to the present disclosure;

FIG. 13 is a main part cross-sectional view illustrating a state in which a ball and a spring are mounted on first and second finger plates of the gripping device of the automatic connector assembling system according to the present disclosure;

FIG. 14 is a main part perspective view illustrating a state in which the gripping device of the automatic connector assembling system according to the present disclosure performs a spiral rotational motion when the gripping device assembles the input connector or the output connector to the connection port of the electrical component; and

FIGS. 15 to 17 are schematic views sequentially illustrating operations in which the first finger plate and the second finger plate of the gripping device of the automatic connector assembling system according to the present disclosure grip the output connector, and then the output connector and the ball come into contact with each other, such that the first finger plate and the second finger plate align the output connector based on the ball in a fastenable direction.

It should be understood that the appended drawings are not necessarily to scale, presenting a somewhat simplified representation of various preferred features illustrative of the basic principles of the invention. The specific design features of the present disclosure as disclosed herein, including, for example, specific dimensions, orientations, locations, and shapes will be determined in part by the particular intended application and use environment.

In the figures, reference numbers refer to the same or equivalent parts of the present disclosure throughout the several figures of the drawing.

### DETAILED DESCRIPTION

It is understood that the term “vehicle” or “vehicular” or other similar term as used herein is inclusive of motor vehicles in general such as passenger automobiles including sports utility vehicles (SUV), buses, trucks, various commercial vehicles, watercraft including a variety of boats and ships, aircraft, and the like, and includes hybrid vehicles, electric vehicles, plug-in hybrid electric vehicles, hydrogen-powered vehicles and other alternative fuel vehicles (e.g., fuels derived from resources other than petroleum). As referred to herein, a hybrid vehicle is a vehicle that has two or more sources of power, for example both gasoline-powered and electric-powered vehicles.

The terminology used herein is for the purpose of describing particular embodiments only and is not intended to be limiting of the present disclosure. As used herein, the singular forms “a,” “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items. Throughout the specification, unless explicitly described to the contrary, the word “comprise” and variations such as “comprises” or “comprising” will be understood to imply the inclusion of stated elements but not the exclusion of any other elements. In addition, the terms “unit”, “-er”, “-or”, and “module” described in the specification mean units for processing at least one function and operation, and can be implemented by hardware components or software components and combinations thereof.

Further, the control logic of the present disclosure may be embodied as non-transitory computer readable media on a computer readable medium containing executable program instructions executed by a processor, controller or the like. Examples of computer readable media include, but are not limited to, ROM, RAM, compact disc (CD)-ROMs, magnetic tapes, floppy disks, flash drives, smart cards and optical data storage devices. The computer readable medium can also be distributed in network coupled computer systems so that the computer readable media is stored and executed in a distributed fashion, e.g., by a telematics server or a Controller Area Network (CAN).

Hereinafter reference will now be made in detail to various embodiments of the present disclosure, examples of which are illustrated in the accompanying drawings and described below. While the invention will be described in conjunction with exemplary embodiments, it will be understood that present description is not intended to limit the invention to those exemplary embodiments. On the contrary, the invention is intended to cover not only the exemplary embodiments, but also various alternatives, modifications, equivalents and other embodiments, which may be included within the spirit and scope of the invention as defined by the appended claims.

Specific structural or functional descriptions described in embodiments of the present specification are exemplified only for the purpose of explaining the embodiments according to the concept of the present disclosure, and the embodiments according to the concept of the present disclosure may be carried out in various forms. In addition, the present disclosure should not be interpreted as being limited to the embodiments disclosed in the present specification, and it should be understood that the present disclosure includes all modifications, equivalents, and alternatives included in the spirit and the technical scope of the present disclosure.

The terms such as “first” and/or “second” in the present specification may be used to describe various constituent elements, but these constituent elements should not be limited by these terms. These terms are used only for the purpose of distinguishing one constituent element from other constituent elements. For example, without departing from the scope according to the concept of the present disclosure, a first constituent element may be referred to as a second constituent element, and similarly, the second constituent element may also be referred to as the first constituent element.

In the present specification, when one constituent element is described as being “coupled” or “connected” to another constituent element, it should be understood that one constituent element can be coupled or connected directly to another constituent element, and an intervening constituent element can also be present between the constituent elements. When one constituent element is described as being “coupled directly to” or “connected directly to” another constituent element, it should be understood that no intervening constituent element is present between the constituent elements. Other expressions, that is, “between” and “just between” or “adjacent to” and “directly adjacent to”, for explaining a relationship between constituent elements, should be interpreted in a similar manner.

Like reference numerals indicate like constituent elements throughout the present specification. The terms used in the present specification are for explaining the exemplary embodiments, not for limiting the present disclosure. Unless particularly stated otherwise in the present specification, a singular form also includes a plural form. The terms “comprise (include)” and/or “comprising (including)” used in the specification are intended to specify the presence of the mentioned constituent elements, steps, operations, and/or elements, but do not exclude presence or addition of one or more other constituent elements, steps, operations, and/or elements.

Hereinafter, an exemplary embodiment of the present disclosure will be described in detail with reference to the accompanying drawings.

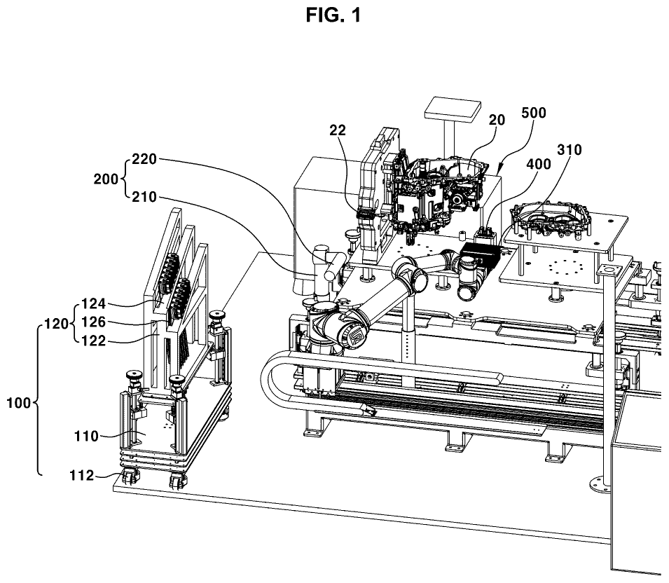

FIG. 1 attached hereto is a perspective view illustrating an automatic connector assembling system according to the present disclosure, and FIG. 10 is a control configuration view of the automatic connector assembling system according to the present disclosure.

With reference to FIGS. 1 and 10, the automatic connector assembling system according to the present disclosure includes a loading device 100, a hanging device 200, an articulated robot 300, which is equipped with a vision camera 310, a gripping device 400, an assembling table 500, a controller 600, and the like.

The loading device 100 is configured such that a plurality of wiring connectors 10, which are each made by connecting one input connector 12 and two or more output connectors 16 by wiring 14, is mounted in a non-aligned state.

As illustrated in FIGS. 1, 2, and 3, the loading device 100 includes a transfer table 110 having rollers 112 mounted on a bottom surface portion thereof, and a mounting frame 120 mounted on the transfer table 110 so that the plurality of wiring connectors 10 is mounted in the non-aligned state.

Particularly, the mounting frame 120 of the loading device 100 may include a plurality of vertical frames 122 mounted at different heights on the transfer table 110, and a plurality of horizontal frames 124 connected between the vertical frames 122 and arranged at different heights to mount the input connectors 12 of the wiring connectors 10. A mounting space 126 having a predetermined interval is formed between the horizontal frames 124.

Therefore, when the input connectors 12 of the wiring connectors 10 are hung and mounted on the horizontal frames 124 arranged at different heights, the output connector 16 and the wiring 14 of the wiring connector 10 may be arranged to be extended downward through the mounting space 126.

As described above, the wiring connector 10 is mounted on the mounting frame 120 in the non-aligned state, and then the transfer table 110 is moved to an automatic connector assembling line by a rolling motion of the roller 112, such that the loading device 100 may be disposed at a predetermined position on the automatic connector assembling line.

Meanwhile, the assembling table 500 is disposed on the automatic connector assembling line, and an electrical component 20 having a plurality of connector connection ports 22 is seated on and fixed to the assembling table 500.

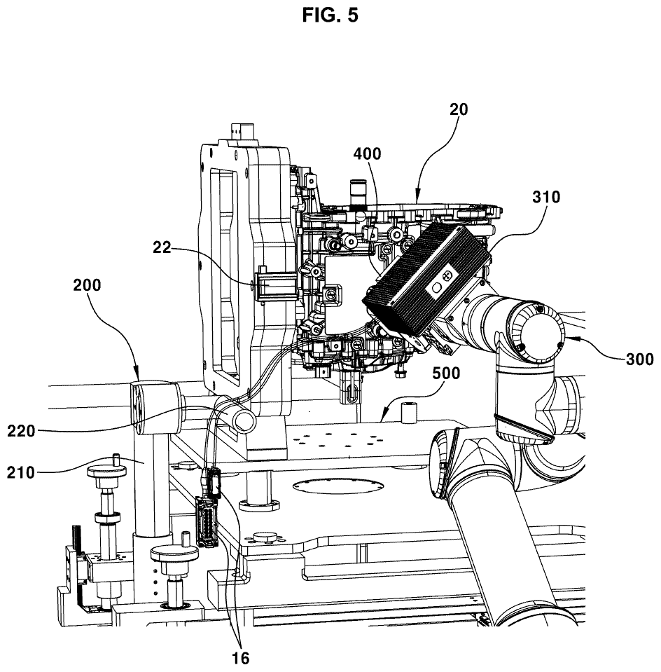

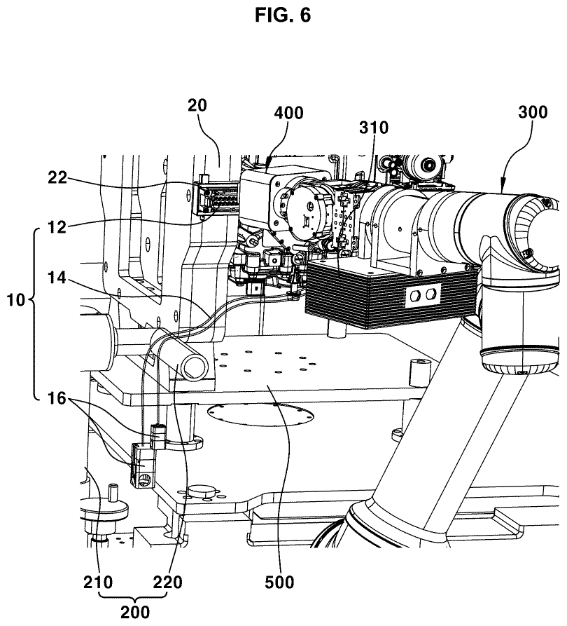

As illustrated in FIGS. 5 and 6, the hanging device 200 is configured such that the wiring 14 and the output connector 16 of the wiring connector 10 are mounted in the non-aligned state when the input connector 12 of the wiring connector 10 inserted and fastened into one of the connection ports 22 of the electrical component 20 by the articulated robot 300 and the gripping device 400.

To this end, as illustrated in FIGS. 1, 5, and 6, the hanging device 200 may include a vertical bar 210 fixed in a vertically arranged state at a front position of one side of the assembling table 500, and a mounting bar 220 connected to an upper end of the vertical bar 210 in a horizontally arranged state.

Therefore, when the input connector 12 of the wiring connector 10 is inserted and fastened into one of the connection ports 22 of the electrical component 20 by the articulated robot 300 and the gripping device 400, the wiring 14 of the wiring connector 10 may be mounted on the mounting bar 220 in the non-aligned state, and simultaneously the output connector 16 may be arranged downward in the non-aligned state.

The articulated robot 300 may be configured to perform forward and rearward motions, leftward and rightward motions, and upward and downward motions so as to freely move to the loading device 100, the assembling table 500, and the hanging device 200. The articulated robot 300 is a publicly-known technology and may be manufactured in a shape in which two to six arms are connected so that the articulated robot 300 is appropriately used for a vehicle assembling line.

Particularly, the articulated robot 300 may be a robot with six degrees of freedom (6DoF) and be configured to perform a total of six types of free motions including three types of motions including upward and downward motions, leftward and rightward motions, and forward and rearward motions performed in parallel with a coordinate axis in addition to three types of motions including upward and downward motions (pitching), horizontal swaying (rolling), leftward and rightward rotations (yawing), and the like on the three-dimensional coordinate axis.

In addition, in order to allow the articulated robot 300 to assemble the wiring connector 10, a transfer rail 320 may be mounted on the automatic connector assembling line to allow leftward and rightward sliding motions of the articulated robot 300 to ensure a range in which the articulated robot 300 freely moves to the loading device 100, the assembling table 500, the hanging device 200, and the like.

Therefore, a lower portion of the articulated robot 300 configured to be slidable leftward and rightward is mounted on the transfer rail 320 mounted on the automatic connector assembling line, such that it is possible to easily ensure distances of the leftward and rightward motions of the articulated robot 300 to assemble the wiring connector 10.

The vision camera 310 is mounted at a tip portion of the articulated robot 300 and configured to acquire a two-dimensional image by capturing an image of the input connector 12 or the output connector 16 of the wiring connector 10 or acquire a three-dimensional image by scanning the input connector 12 or the output connector 16 of the wiring connector 10.

Therefore, the vision camera 310 transmits a two-dimensional image signal, which is obtained by primarily capturing an image of the input connector 12 of the wiring connector 10 mounted in the non-aligned state on the mounting frame 120 of the loading device 100, to the controller 600 and transmits a three-dimensional image signal, which is obtained by secondarily scanning the input connector 12 of the wiring connector 10, to the controller 600. In addition, the vision camera 310 transmits a three-dimensional image signal, which is obtained by scanning the output connector 16 of the wiring connector 10 mounted in the non-aligned state on the mounting bar 220 of the hanging device 200, to the controller 600.

In particular, the gripping device 400 is mounted at a tip end of the articulated robot 300 and configured to grip the input connector 12 or the output connector 16 of the wiring connector 10.

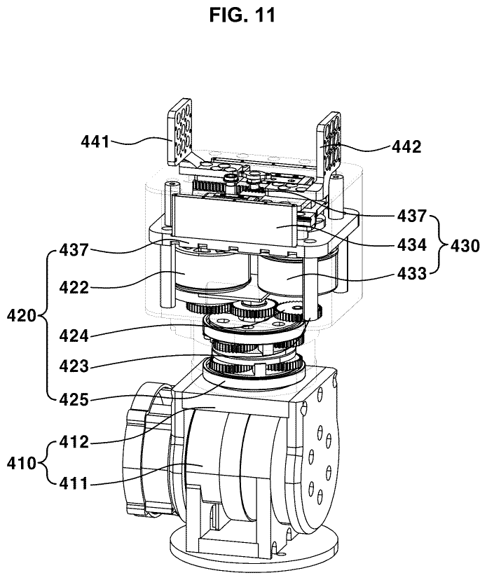

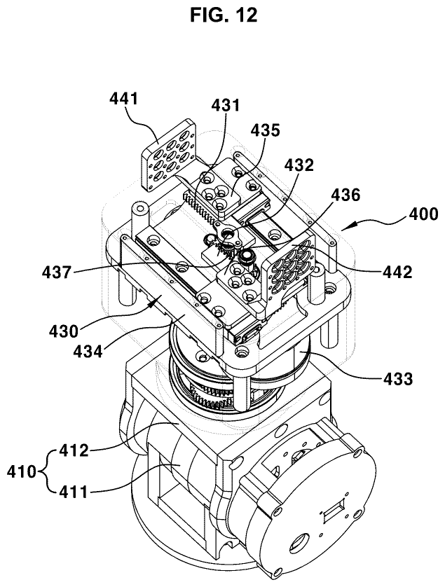

As illustrated in FIGS. 11 and 12, the gripping device 400 includes a first finger plate 441 and a second finger plate 442 configured to grip the input connector 12 or the output connector 16 of the wiring connector 10, a first drive device 410 configured to rotate the first finger plate 441 and the second finger plate 442 in an upward/downward direction, a second drive device 420 configured to rotate the first finger plate 441 and the second finger plate 442 in a leftward/rightward direction, and a third drive device 430 configured to rectilinearly move the first finger plate 441 and the second finger plate 442 in a forward/rearward direction.

The first drive device 410 may be mounted at the tip end of the articulated robot 300 and include a first motor 411 mounted at the tip end of the articulated robot 300, and an upward/downward rotation frame 412 connected to an output part of the first motor 411 and configured to be rotatable upward or downward.

In this case, the second drive device 420, the third drive device 430, the first finger plate 441, the second finger plate 442, and the like are stacked and assembled in a predetermined arrangement on an outer surface portion of the upward/downward rotation frame 412.

Therefore, when the first motor 411 operates in response to a control signal of the controller 600, the upward/downward rotation frame 412 connected to the output part of the first motor 411 rotates upward or downward, and the second drive device 420, the third drive device 430, the first finger plate 441, and the second finger plate 442 stacked and assembled in the predetermined arrangement on the upward/downward rotation frame 412 also rotate in the same direction.

The second drive device 420 may include a base plate 421 mounted between the first drive device 410 and the finger plates 441 and 442, a second motor 422 mounted on a bottom surface portion of one side of the base plate 421, a rotary shaft 423 mounted at a center position of the outer surface portion of the upward/downward rotation frame 412, and a gear train 424 mounted between the output part of the second motor 422 and the rotary shaft 423 and made by combining a plurality of gears configured to rotate the base plate 421 leftward or rightward about the rotary shaft 423.

In this case, one of the gears of the gear train 424 and the base plate 421 are connected by a connection bar 425.

Therefore, when the second motor 422 operates in response to a control signal of the controller 600, the gear train 424 rotates in a leftward or rightward direction about the rotary shaft 423, the base plate 421 connected to one of the gears of the gear train 424 by the connection bar 425 also rotates in the same direction, and the third drive device 430, which is assembled to the base plate 422, and the first and second finger plates 441 and 442 also rotate in the same direction.

The third drive device 430 may include a third motor 433 mounted on a bottom surface portion of the other side of the base plate 421 in the state in which the base plate 421 is mounted between the first drive device 410 and the finger plates 441 and 442, a gearbox 434 connected to an output part of the third motor 433 and mounted on an upper surface portion of the base frame 421, a first rail plate 435 and a second rail plate 436 mounted at two opposite positions of an upper surface of the gearbox 434, a first rack gear 431 fastened to the first rail plate 435 and configured to be movable forward or rearward, a second rack gear 432 fastened to the second rail plate 436 and configured to be movable forward or rearward, and a pinion 437 connected to an output part of the gearbox 434 and configured to engage with the first rack gear 431 and the second rack gear 432.

In this case, the first finger plate 441 is connected to an outer end of the first rack gear 431 fastened to the first rail plate 435 and configured to be movable forward or rearward, and the second finger plate 442 is connected to an outer end of the second rack gear 432 fastened to the second rail plate 436 and configured to be movable forward or rearward.

Therefore, when the third motor 433 operates in response to a control signal of the controller 600, rotational power of the third motor 433 is outputted through the output part of the gearbox 434, the pinion 437 connected to the output part of the gearbox 434 rotates, and the first rack gear 431 and the second rack gear 432, which engage with the pinion 437, move forward or rearward.

At the same time, the first finger plate 441, which is connected to the first rack gear 431, and the second finger plate 442, which is connected to the second rack gear 432, move forward to grip the input connector 12 or the output connector 16 or move rearward to release the input connector 12 or the output connector 16.

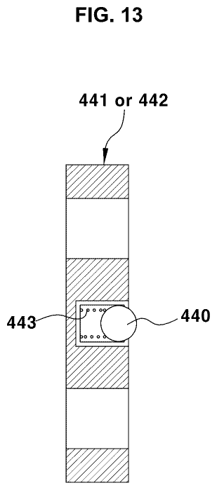

With reference to FIG. 13, balls 440 are mounted in an inner surface of the first finger plate 441 and an inner surface of the second finger plate 442 so as to enter or exit the inner surface of the first finger plate 441 and the inner surface of the second finger plate 442, and springs 443 are embedded in the first finger plate 441 and the second finger plate 442 and elastically support the balls 440.

When the electric current (e.g., 500 mA) at a preset level is applied to the third motor 433 of the third drive device 430 by controlling the electric current in a proportional-integral-derivative control (PID) manner by the controller 600, the first finger plate 441, which is connected to the first rack gear 431, and the second finger plate 442, which is connected to the second rack gear 432, move forward, such that a force for holding the input connector 12 or the output connector 16 may be at a preset level or higher.

In this case, when the force for holding the input connector 12 or the output connector 16 is at a preset level or higher as the first finger plate 441 and the second finger plate 442 move forward, the balls 440 are pushed in a state in which the balls 440 are in contact with the input connector 12 or the output connector 16, such that the balls 440 are inserted into the first finger plate 441 and the second finger plate 442 while compressing the springs 443.

In contrast, when the electric current (e.g., 50 mA), which is lower than the electric current at the preset level, is applied to the third motor 433 of the third drive device 430 by controlling the electric current in the PID manner by the controller 600, the first finger plate 441 and the second finger plate 442 finely move rearward in the state in which the first finger plate 441 and the second finger plate 442 are maximally moved forward, such that the force for holding the input connector 12 or the output connector 16 may decrease to less than a preset level.

In this case, when the force by which the first finger plate 441 and the second finger plate 442 hold the input connector 12 or the output connector 16 decreases to less than the preset level, the balls 440 protrude from the inside of the first and second finger plates 441 and 442 by elastic restoring forces of the springs 443, and the balls 440 come into contact with the input connector 12 or the output connector 16.

Therefore, in the state in which the balls 440 protrude, like hinge shafts, and are in contact with the input connector 12 or the output connector 16, the first finger plate 441 and the second finger plate 442 are relatively rotated about the balls 440 by the operations of the articulated robot 300 and the gripping device 400, such that a direction in which the input connector 12 or the output connector 16 is inserted and fastened into the connection port 22 of the electrical component 20 may be changed.

Meanwhile, the controller 600 is configured to control the motions of the articulated robot 300 and the gripping device 400 to grip the input connector 12 or the output connector 16 of the wiring connector 10 and fasten the input connector 12 or the output connector 16 of the wiring connector 10 to the connection port 22 of the electrical component 20 on the basis of image capturing information of the vision camera 310.

To this end, the controller 600 may be configured to accurately detect a mounting position for the input connector 12 in the non-aligned state by performing deep learning computation on the basis of a two-dimensional image signal of the input connector 12 captured by the vision camera 310, i.e., a two-dimensional image signal made by repeatedly capturing, by the vision camera 310, images of the input connectors 12 of the wiring connector 10 mounted on the loading device 100 in the non-aligned state.

In addition, on the basis of the three-dimensional image signal of the input connector 12 or the output connector 16 scanned and captured by the vision camera 310, the controller 600 may be configured to detect a three-dimensional precise position and arrangement angle of the input connector 12 of the wiring connector 10, which is mounted on the loading device 100 in the non-aligned state, or the output connector 16 of the wiring connector 10 mounted on the hanging device 200 in the non-aligned state.

In addition, on the basis of a result of detecting the three-dimensional precise position and arrangement angle of the input connector 12 or the output connector 16 of the wiring connector 10, the controller 600 may be configured to control various motions of the articulated robot 300 and the gripping device 400 to grip the input connector 12 or output connector 14 and insert and fasten the input connector 12 or output connector 14 into the connection port 22 of the electrical component 20.

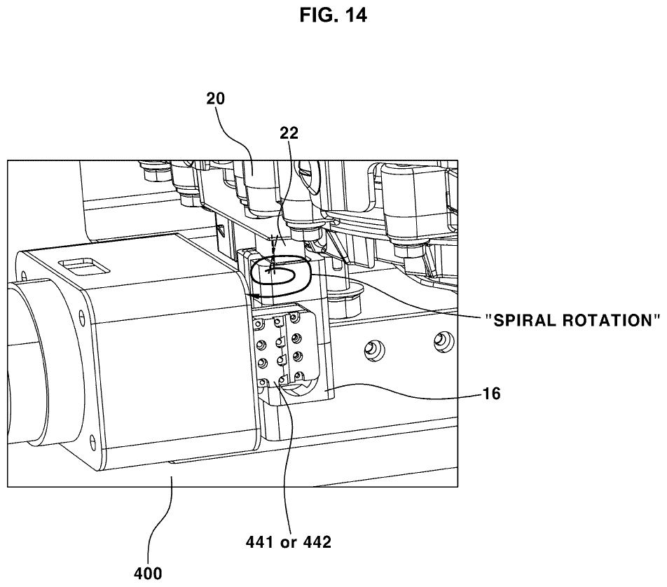

Moreover, as illustrated in FIG. 14, the controller 600 may perform control to rotate the articulated robot 300 and the gripping device 400 in a spiral direction so that the input connector 12 or the output connector 16 is accurately inserted and fastened into the corresponding connection port 22 of the electrical component 20 when the gripping device 400 grips the input connector 12 or the output connector 16 and fasten the input connector 12 or the output connector 16 to the connection port 22 of the electrical component 20.

In more detail, in the state in which the first finger plate 441 and the second finger plate 442 of the gripping device 400 grip the input connector 12 or the output connector 16, the articulated robot 300 and the gripping device 400 are spirally rotated by the rotational motion control of the controller 600 while increasing a rotation radius to about 4 mm based on an axial direction in which the input connector 12 or the output connector 16 is inserted into the connection port 22 of the electrical component 20, such that the input connector 12 or the output connector 16 may be accurately inserted and fastened into the connection port 22 of the electrical component 20.

In this case, an operation flow of the automatic connector assembling system configured as described above will be sequentially described.

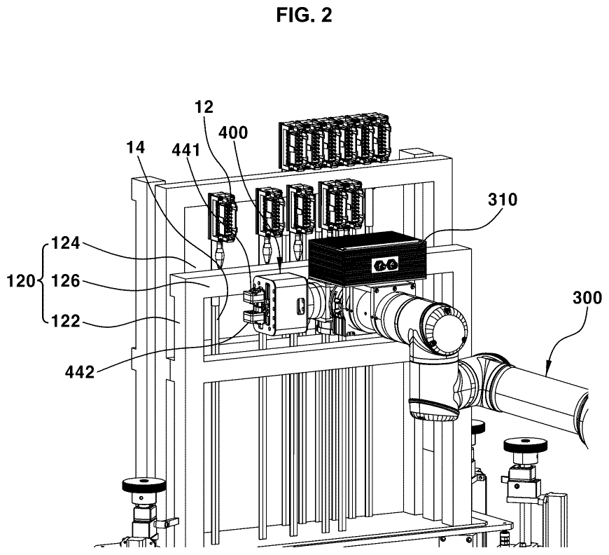

First, as illustrated in FIG. 2, the plurality of wiring connectors 10 is mounted on the loading device 100 in the non-aligned state.

That is, when the operator hangs and fixes the input connector 12 of the wiring connector 10 onto each of the horizontal frames 124 arranged at different heights, the output connector 16 and the wiring 14 may be arranged to be extended downward through the mounting space 126 between the horizontal frames 124.

Next, as illustrated in FIG. 2, the vision camera 310, which is mounted at the tip portion of the articulated robot 300, is arranged adjacent to the front side of the input connector 12 mounted on the loading device 100 by the operation of the articulated robot 300, such that the vision camera 310 scans the input connector 12.

Continuously, the two-dimensional image signal of the input connector 12, which is primarily captured by the vision camera 310, and the three-dimensional image signal of the input connector 12, which is secondarily scanned and captured, are transmitted to the controller 600.

Therefore, the controller 600 accurately detects the mounting position for the input connector 12 in the non-aligned state by performing deep learning computation on the basis of the two-dimensional image signal of the input connector 12 captured by the vision camera 310, and the controller 600 detects the three-dimensional precise position and arrangement angle of the input connector 12 on the basis of the three-dimensional image signal of the input connector 12.

Next, on the basis of the three-dimensional precise position and arrangement angle of the input connector 12, the controller 600 provides an operation control signal to allow the articulated robot 300 to move to the position at which the gripping device 400 grips the input connector 12.

Continuously, the first finger plate 441 and the second finger plate 442 of the gripping device 400 may be disposed to be spaced apart from each other, by a motion operation of the articulated robot 300, at positions at which the first finger plate 441 and the second finger plate 442 may grip the input connector 12, i.e., the two opposite positions of the input connector 12.

Next, when the electric current is applied to the third motor 433 of the third drive device 430 among the components of the gripping device 400 by the controller 600, an operation of outputting rotational power of the third motor 433 through the output part of the gearbox 434 simultaneously with operating the third motor 433, an operation of rotating the pinion 437 connected to the output part of the gearbox 434, and an operation of moving forward the first rack gear 431 and the second rack gear 432 engaging with the pinion 437 are continuously performed.

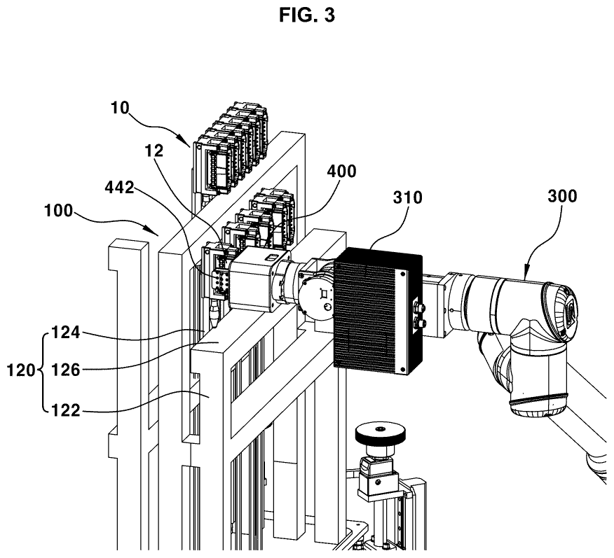

Therefore, as illustrated in FIG. 3, the first finger plate 441, which is connected to the first rack gear 431, and the second finger plate 442, which is connected to the second rack gear 432, move forward and grip the input connector 12.

For example, when the electric current (e.g., 500 mA) at a preset level is applied to the third motor 433 of the third drive device 430 by controlling the electric current in the PID manner by the controller 600, the first finger plate 441, which is connected to the first rack gear 431, and the second finger plate 442, which is connected to the second rack gear 432, move forward and hold the input connector 12 by a force at a preset level.

In this case, the balls 440, which are mounted in the inner surface of the first finger plate 441 and the inner surface of the second finger plate 442 so as to enter or exit the inner surface of the first finger plate 441 and the inner surface of the second finger plate 442, are inserted into the first finger plate 441 and the second finger plate 442 while compressing the springs 443.

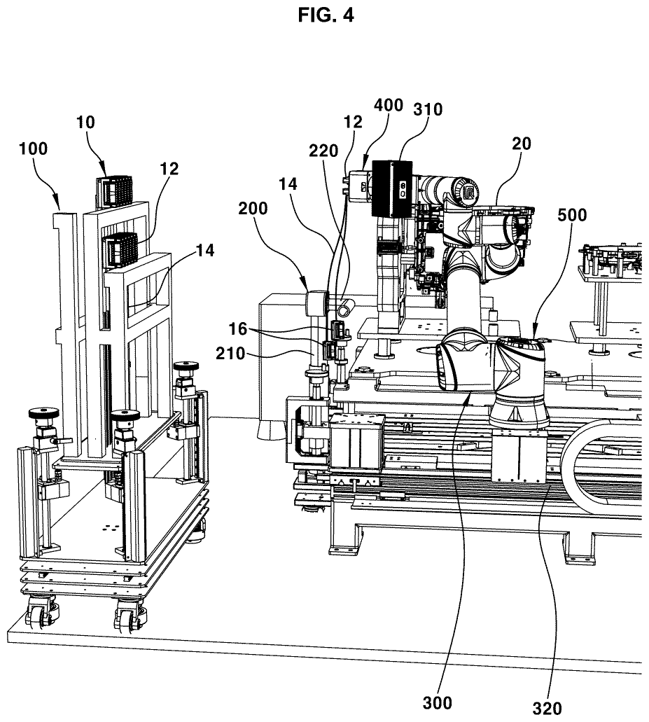

Next, as illustrated in FIGS. 4 and 5, as the articulated robot 300 and the gripping device 400 move in response to a control signal of the controller 600 toward the electrical component 20 seated on the assembling table 500, the input connector 12 gripped by the first finger plate 441 and the second finger plate 442 of the gripping device 400 is placed at the position at which the input connector 12 may be inserted into one of the connection ports 22 of the electrical component 20.

Next, as illustrated in FIG. 6, the articulated robot 300 and the gripping device 400 move in response to a control signal of the controller 600 in the direction in which the input connector 12 is inserted into one of the connection ports 22 of the electrical component 20, such that the input connector 12 is inserted and fastened into one of the connection ports 22 of the electrical component 20.

In this case, when the input connector 12 is moved, inserted, and fastened into one of the connection ports 22 of the electrical component 20 by the articulated robot 300 and the gripping device 400, the wiring 14 of the wiring connector 10 is mounted in the non-aligned state on the mounting bar 220 of the hanging device 200, and simultaneously the output connector 16 floats in the air while being arranged downward in the non-aligned state, as illustrated in FIGS. 5 and 6.

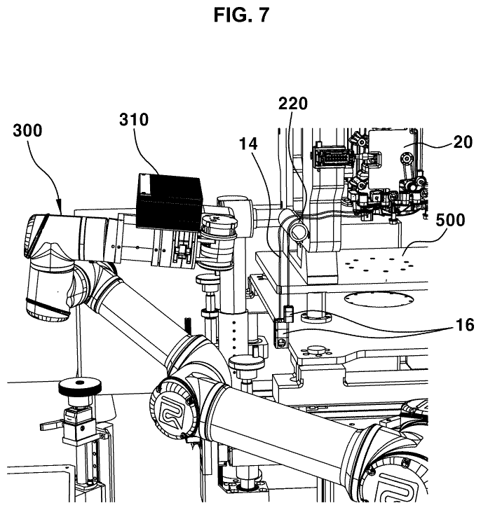

Next, the motion of the articulated robot 300 operates in response to a control signal of the controller 600, such that as illustrated in FIG. 7, the gripping device 400 is placed at the position spaced apart, at a predetermined distance, from the output connector 16 of the wiring connector 10 mounted in the non-aligned state on the mounting bar 220 of the hanging device 200.

Next, as illustrated in FIG. 7, the vision camera 310 mounted at the tip portion of the articulated robot 300 is arranged adjacent to the output connector 16 of the wiring connector 10 mounted in the non-aligned state on the mounting bar 220 of the hanging device 200, such that the vision camera 310 scans and captures an image of the output connector 16, and the captured three-dimensional image signal of the output connector 16 is transmitted to the controller 600.

Therefore, the controller 600 detects the three-dimensional precise position and arrangement angle of the output connector 16 on the basis of the three-dimensional image signal of the output connector 16 captured by the vision camera 310.

Next, on the basis of the three-dimensional precise position and arrangement angle of the output connector 16, the controller 600 provides an operation control signal to allow the articulated robot 300 to move to the position at which the gripping device 400 may grip the output connector 12.

Continuously, the first finger plate 441 and the second finger plate 442 of the gripping device 400 may be disposed to be spaced apart from each other, by the motion operation of the articulated robot 300, at the positions, i.e., the two opposite positions of the output connector 12 at which the first finger plate 441 and the second finger plate 442 may grip the output connector 12.

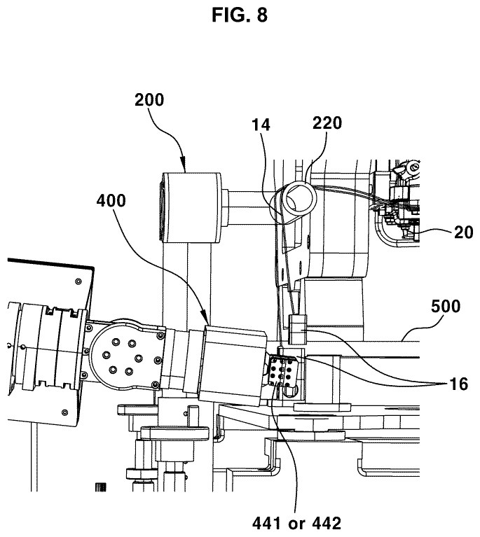

Next, when the electric current is applied to the third motor 433 of the third drive device 430 among the components of the gripping device 400 by the controller 600, the operation of outputting rotational power of the third motor 433 through the output part of the gearbox 434 simultaneously by operating the third motor 433, the operation of rotating the pinion 437 connected to the output part of the gearbox 434, and the operation of moving forward the first rack gear 431 and the second rack gear 432 engaging with the pinion 437 are continuously performed. Therefore, as illustrated in FIG. 8, the first finger plate 441, which is connected to the first rack gear 431, and the second finger plate 442, which is connected to the second rack gear 432, move forward and grip the output connector 16.

For example, when the electric current (e.g., 500 mA) at a preset level is applied to the third motor 433 of the third drive device 430 by controlling the electric current in the PID manner by the controller 600, the first finger plate 441, which is connected to the first rack gear 431, and the second finger plate 442, which is connected to the second rack gear 432, move forward and hold the output connector 12 by a force at a preset level.

In this case, the balls 40 mounted in the inner surface portion of the first finger plate 441 and the inner surface portion of the second finger plate 442 are pushed in the state in which the balls 40 are in contact with the output connector 14, such that the balls 440 are inserted into the first finger plate 441 and the second finger plate 442 while compressing the springs 443.

Next, the articulated robot 300 and the gripping device 400 move in response to a control signal of the controller 600 toward the electrical component 20 seated on the assembling table 500, the output connector 16 gripped by the first finger plate 441 and the second finger plate 442 of the gripping device 400 is placed at the position at which the output connector 16 may be inserted into another of the connection ports 22 of the electrical component 20.

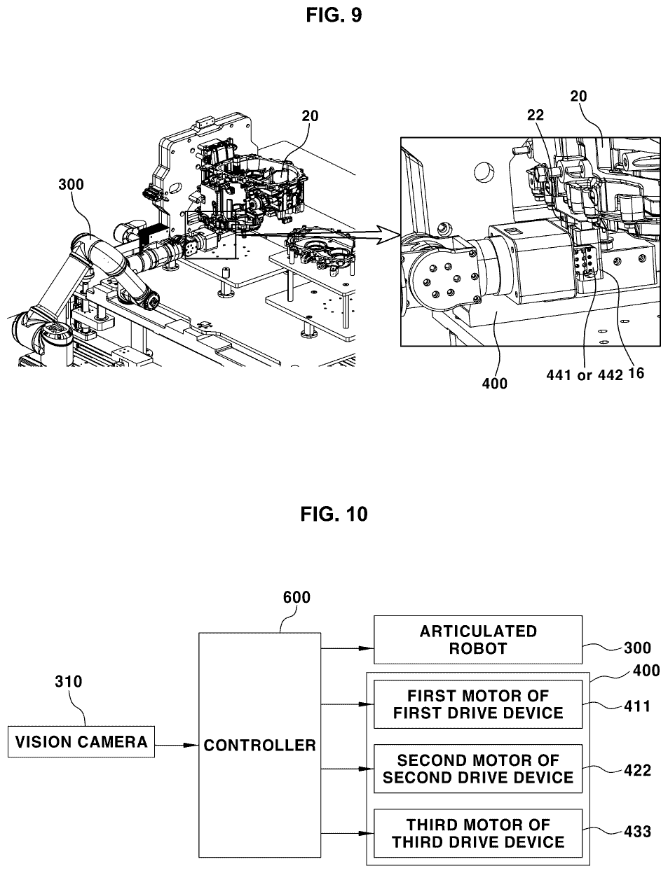

Continuously, as illustrated in FIG. 9, the articulated robot 300 and the gripping device 400 move in response to a control signal of the controller 600 in the direction in which the output connector 16 is inserted into another of the connection ports 22 of the electrical component 20, such that the output connector 16 may be inserted and fastened into another of the connection ports 22 of the electrical component 20.

Meanwhile, in the state in which the first finger plate 441 and the second finger plate 442 grip the output connector 14, the direction in which the output connector 16 is inserted and fastened into the connection port 22 of the electrical component 20 may be changed.

To this end, when the electric current (e.g., 50 mA), which is lower than the electric current at the preset level, is applied to the third motor 433 of the third drive device 430 by controlling the electric current in the PID manner by the controller 600, the first finger plate 441 and the second finger plate 442 finely move rearward from the state in which the first finger plate 441 and the second finger plate 442 are maximally moved forward, such that the force for holding the output connector 16 may decrease to less than a preset level.

In this case, when the force by which the first finger plate 441 and the second finger plate 442 hold the output connector 16 decreases to less than the preset level, the balls 440 protrude from the inside of the first and second finger plates 441 and 442 by elastic restoring forces of the springs 443, and the balls 440 come into contact with the output connector 16.

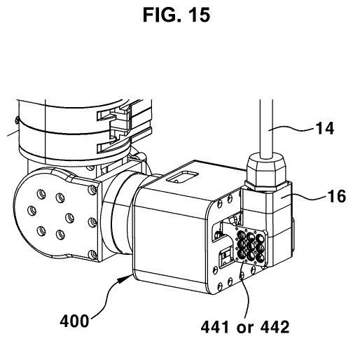

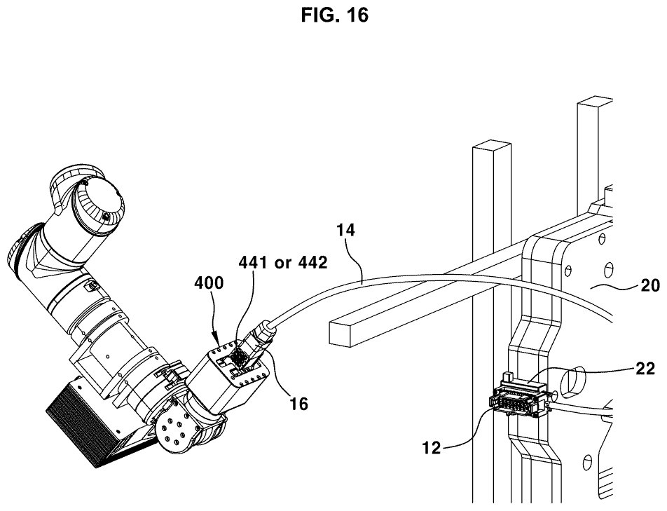

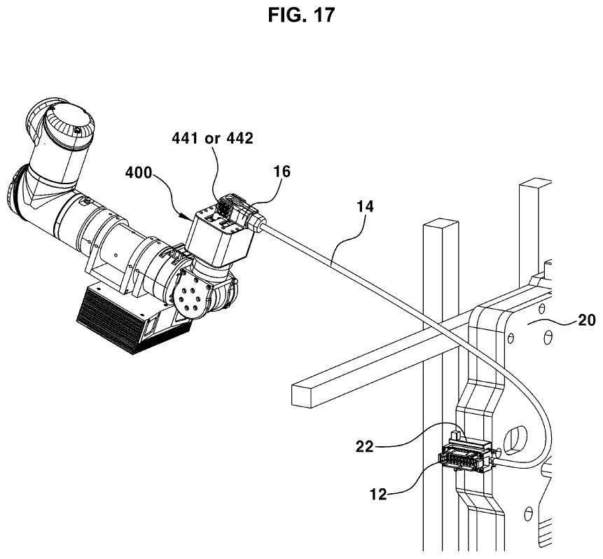

Therefore, in the state in which the balls 440 protrude, like hinge shafts, and are in contact with the output connector 16, the first finger plate 441 and the second finger plate 442 are rotated about the balls 440 relative to the output connector 16 by the motion operations of the articulated robot 300 and the gripping device 400 as sequentially illustrated in FIGS. 15 to 17, such that the direction in which the output connector 16 is inserted and fastened into the connection port 22 of the electrical component 20 may be changed.

Of course, when the electric current (e.g., 500 mA) at the preset level is applied to the third motor 433 of the third drive device 430 by controlling the electric current in the PID manner by the controller 600 again after the direction in which the output connector 16 is inserted and fastened into the connection port 22 of the electrical component 20 is changed, the first finger plate 441 and the second finger plate 442 move forward again and hold the output connector 12 with the force at the preset level.

As described above, in the state in which the direction in which the output connector 12 is inserted and fastened into the connection port 22 of the electrical component 20 is changed, the articulated robot 300 and the gripping device 400 move in response to a control signal of the controller 600 in the direction in which the output connector 16 is inserted into another of the connection ports 22 of the electrical component 20, such that the output connector 16 may be accurately inserted and fastened into another of the connection ports 22 of the electrical component 20.

Moreover, in the state in which the first finger plate 441 and the second finger plate 442 of the gripping device 400 grip the output connector 16, the articulated robot 300 and the gripping device 400 are spirally rotated by the rotational motion control of the controller 600 while increasing a rotation radius to about 4 mm based on an axial direction in which the output connector 16 is inserted into the connection port 22 of the electrical component 20, as illustrated in FIG. 14, such that the input connector 12 or the output connector 16 may be more accurately inserted and fastened into the connection port 22 of the electrical component 20.

As described above, even though the wiring connector 10 is mounted in the non-aligned state on the loading device 100 or the hanging device 200, the position and arrangement angle of the input connector 12 or the output connector 16 of the wiring connector 10 may be accurately detected by deep learning computation and the like, and the gripping device 400 may grip the input connector 12 or the output connector 16 and automatically insert and fasten the input connector 12 or the output connector 16 into the corresponding connection port 22 of the electrical component 20 on the basis of the detected position and arrangement angle, thereby implementing the automation of the connector assembling process.

While the present disclosure has been described in detail with reference to one embodiment, the protection scope of the present disclosure is not limited to the above-mentioned embodiment. It should be construed that many variations and modifications made by those skilled in the art using the basic concept of the present disclosure, which is defined in the following claims, will also belong to the right scope of the present disclosure.

The invention has been described in detail with reference to preferred embodiments thereof. However, it will be appreciated by those skilled in the art that changes may be made in these embodiments without departing from the principles and spirit of the invention, the scope of which is defined in the appended claims and their equivalents.

What is claimed is:

1. A gripping device for assembling a connector in a vehicle, the gripping device comprising:
first and second plates configured to grip an input connector or an output connector of a wiring connector;
one or more drive devices mounted on a robot and configured to: rotate the first and second plates in an upward/downward direction, rotate the first and second plates in a leftward/rightward direction, and rectilinearly move the first and second plates in a forward/rearward direction.

2. The gripping device of claim 1, wherein the one or more drive devices comprise a first drive device mounted at a tip end of the robot for rotating the first and second plates in the upward/downward direction, a second drive device mounted between the first drive device and the first and second plates for rotating the first and second plates in the leftward/rightward direction, and a third drive device mounted between the first drive device mounted between the first drive device and the first and second plates for rectilinearly moving the first and second plates in the forward/rearward direction.

3. The gripping device of claim 2, wherein the first drive device comprises:
a first motor mounted on the robot; and
an upward/downward rotation frame connected to an output part of the first motor, configured to be rotatable upward or downward, and connected to the second drive device.

4. The gripping device of claim 2, wherein the second drive device comprises:
a base plate;
a second motor mounted on a bottom surface portion of one side of the base plate;
a rotary shaft mounted at a center position of an outer surface portion of the upward/downward rotation frame; and
a gear train mounted between the output part of the second motor and the rotary shaft and configured by combining a plurality of gears configured to rotate the base plate leftward or rightward about the rotary shaft.

5. The gripping device of claim 2, wherein the third drive device comprises:
a third motor mounted on a bottom surface portion of the other side of the base plate;
a gearbox connected to an output part of the third motor and mounted on an upper surface portion of the base frame;
first and second rail plates mounted on an upper surface portion of the gearbox;
a first rack gear fastened to the first rail plate, configured to be movable forward or rearward, and having an outer end to which the first plate is connected;
a second rack gear fastened to the second rail plate, configured to be movable forward or rearward, and having an outer end to which the second plate is connected; and
a pinion connected to an output part of the gearbox and configured to engage with the first and second rack gears.

6. The gripping device of claim 1, wherein balls are mounted in inner surfaces of the first and second plates so as to enter or exit the inner surfaces of the first and second plates, and springs are embedded in the first and second plates and elastically support the balls.

7. An automatic connector assembling system for vehicle assembly comprising:
a loading device configured to mount a plurality of wiring connectors, configured by connecting an input connector and an output connector by wiring, in a non-aligned state;
an assembling table onto which an electrical component having a plurality of connection ports is seated and fixed;
a hanging device configured to mount the wiring and output connectors in the non-aligned state when the input connector is inserted and fastened into one of the connection ports of the electrical component;
an articulated robot configured to perform forward and rearward motions, leftward and rightward motions, and upward and downward motions to move to the loading device, the assembling table, and the hanging device;
a vision camera mounted on the robot to capture a two-dimensional image or a three-dimensional image of the input connector or the output connector;
a gripping device mounted on the robot and configured to grip the input connector or the output connector; and
a controller configured to control motions of the robot and the gripping device to grip the input connector or the output connector and fasten the input connector or the output connector to the connection port of the electrical component based on image capturing information obtained from the vision camera.

8. The automatic connector assembling system of claim 7, wherein the loading device comprises:
a transfer table having a roller mounted on a bottom surface portion thereof; and
a mounting frame mounted on the transfer table so that the plurality of wiring connectors is mounted in the non-aligned state.

9. The automatic connector assembling system of claim 8, wherein the mounting frame comprises:
a plurality of vertical frames mounted at different heights on the transfer table;
a plurality of horizontal frames arranged at different heights, connected between the vertical frames, and configured to mount and fix the input connector of the wiring connector; and
a mounting space formed between the horizontal frames to arrange the wiring and output connectors of the wiring connector downward.

10. The automatic connector assembling system of claim 7, wherein the hanging device comprises:
a vertical bar arranged at a front position of one side of the assembling table; and
a mounting bar connected to an upper end of the vertical bar so that the wiring and output connectors are mounted in the non-aligned state when the input connector is inserted and fastened into one of the connection ports of the electrical component by the robot and the gripping device.

11. The automatic connector assembling system of claim 7, further comprising:
a transfer rail on which a lower portion of the articulated robot is mounted to be slidable leftward or rightward to increase distances of leftward and rightward motions of the articulated robot.

12. The automatic connector assembling system of claim 7, wherein the vision camera is configured to transmit a two-dimensional image signal, which is obtained by primarily capturing an image of the input connector mounted on the loading device, to the controller and transmit a three-dimensional image signal, which is obtained by secondarily capturing an image of the input connector mounted on the loading device, to the controller, and the vision camera is configured to transmit a three-dimensional image signal, which is obtained by capturing an image of the output connector mounted on the hanging device, to the controller.

13. The automatic connector assembling system of claim 7, wherein the gripping device comprises:
first and second plates configured to hold the input connector or the output connector of the wiring connector;
balls mounted on the first and second plates so as to enter or exit the inner surfaces of the first and second plates;
springs embedded in the first and second plates and configured to elastically support the balls;
a first drive device mounted on the robot and configured to rotate the first and second plates in an upward/downward direction;
a second drive device mounted between the first drive device and the first and second plates and configured to rotate the first and second plates in a leftward/rightward direction; and
a third drive device mounted between the first drive device and the first and second plates and configured to rectilinearly move the first and second plates in a forward/rearward direction.

14. The automatic connector assembling system of claim 13, wherein the first drive device comprises:
a first motor mounted on the robot; and
an upward/downward rotation frame connected to an output part of the first motor, configured to be rotatable upward or downward, and connected to the second drive device,
wherein the second drive device comprises:
a base plate;
a second motor mounted on a bottom surface portion of one side of the base plate;
a rotary shaft mounted at a center position of an outer surface portion of the upward/downward rotation frame; and
a gear train mounted between an output part of the second motor and the rotary shaft and configured by combining a plurality of gears configured to rotate the base plate leftward or rightward about the rotary shaft, and
wherein the third drive device comprises:
a third motor mounted on a bottom surface portion of the other side of the base plate;
a gearbox connected to an output part of the third motor and mounted on an upper surface portion of the base frame;
first and second rail plates mounted on an upper surface portion of the gearbox;
a first rack gear fastened to the first rail plate, configured to be movable forward or rearward, and having an outer end to which the finger plate is connected;
a second rack gear fastened to the second rail plate, configured to be movable forward or rearward, and having an outer end to which the finger plate is connected;
a pinion connected to an output part of the gearbox and configured to engage with the first and second rack gears; and
a connection bar provided between one of the gears of the gear train and the base plate.

15. The automatic connector assembling system of claim 13, wherein when a force by which the first and second plates hold the input connector or the output connector is at a preset level or higher by electric current control of the controller in a state in which the balls are in contact with the input connector or the output connector, the balls are inserted into the first and second plates while compressing the springs.

16. The automatic connector assembling system of claim 13, wherein when a force by which the first and second plates hold the input connector or the output connector is less than a preset level by electric current control of the controller, the balls protrude from the inner surfaces of the first and second plates and come into contact with the input connector or the output connector by elastic restoring forces of the springs.

17. The automatic connector assembling system of claim 7, wherein the controller is configured to detect a position of the input connector of the wiring connector mounted on the loading device in the non-aligned state by performing deep learning on the basis of a two-dimensional image signal of the input connector captured by the vision camera.

18. The automatic connector assembling system of claim 7, wherein the controller is configured to detect a three-dimensional precise position and arrangement angle of the input connector of the wiring connector mounted on the loading device in the non-aligned state or the output connector of the wiring connector mounted on the hanging device on the basis of a three-dimensional image signal of the input connector or the output connector captured by the vision camera.

19. The automatic connector assembling system of claim 18, wherein the controller is configured to control motions of the robot and the gripping device to grip the input connector or the output connector and fasten the input connector or the output connector to the connection port of the electrical component on the basis of a result of detecting the three-dimensional precise position and arrangement angle of the input connector or the output connector of the wiring connector.

20. The automatic connector assembling system of claim 19, wherein the controller is configured to perform control to rotate the robot and the gripping device in a spiral direction when the gripping device grips the input connector or the output connector and fastens the input connector or the output connector to the connection port of the electrical component.
